(19) United States
(12) Patent Application Publication
(10) Pub. No.: US 2021/0103927 A1
(43) Pub. Date: Apr. 8, 2021

(54) Method, System, and Computer Program Product for Simulating Fraud Detection Rules

(71) Applicant: Visa International Service Association, San Francisco, CA (US)

(72) Inventors: Navendu Misra, Austin, TX (US); Biswajit Das, Foster City, CA (US); Durga Kala, Cupertino, CA (US); Harshitha S V, Bangalore (IN); Juharasha Shaik, Fremont, CA (US)

(21) Appl. No.: 16/592,374

(22) Filed: Oct. 3, 2019

(51) Int. Cl. G06Q 20/40

(52) U.S. Cl. CPC G06Q 20/4016

(57) ABSTRACT

Methods, systems, and computer program products are provided for simulating fraud detection rules. The method includes: receiving user input including at least one proposed fraud detection rule in at least one input field of a user interface; simulating the at least one proposed fraud detection rule by: querying historical transaction data based on the at least one proposed fraud detection rule; and generating a simulation result for the at least one proposed fraud detection rule based on the queried historical transaction data; and displaying the simulation result on the user interface. The simulation result is displayed on the user interface asynchronously and in near real-time relative to receiving the user input.

### BACKGROUND

### 1. Field

This disclosure relates generally to fraud detection rules and, in some non-limiting embodiments or aspects, to a method, system, and computer program product for simulating fraud detection rules.

### 2. Technical Considerations

Techniques have been developed to monitor transactions and identify fraudulent transactions before, or soon after, such transactions are initiated. These techniques include implementing fraud rules during transaction processing to identify fraudulent transactions. Once a transaction is identified as fraudulent, the transaction may be immediately rejected, flagged for manual approval, and/or approved and logged for later review.

Before implementing a fraud rule, the fraud rule may be tested for its expected effectiveness in identifying fraudulent transactions. This testing includes implementing the fraud rule on historical transaction data to determine how effective the fraud rule is in identifying fraudulent transactions among the historical transaction data. Issuers commonly test proposed fraud rules prior to implementation. Currently, issuers testing proposed fraud rules manually author these proposed rules, which may be simulated only after the issuer has completed authoring the proposed fraud rules. The simulation results associated with the proposed fraud rules are not available until the rule is fully authored by the issuer and the issuer has actively prompted the simulation to run. The current techniques for authoring and simulating proposed fraud rules is cumbersome, inefficient, and time consuming.

### SUMMARY

According to non-limiting embodiments or aspects, provided is a method for simulating fraud detection rules including: receiving, with at least one processor, user input including at least one proposed fraud detection rule in at least one input field of a user interface; simulating, with at least one processor, the at least one proposed fraud detection rule by: querying, with at least one processor, historical transaction data based on the at least one proposed fraud detection rule; and generating, with at least one processor, a simulation result for the at least one proposed fraud detection rule based on the queried historical transaction data; and displaying, with at least one processor, the simulation result on the user interface, where the simulation result is displayed on the user interface asynchronously and in near real-time relative to receiving the user input.

In non-limiting embodiments or aspects, the simulation result may include effectiveness data associated with the at least one proposed fraud detection rule. The effectiveness data may include at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof. The at least one proposed fraud detection rule may be associated with a data element from ISO 8583. The at least one proposed fraud detection rule may include a plurality of rule segments including a first rule segment and a second rule segment. Displaying the simulation result on the user interface may include: displaying a first simulation result in response to the first rule segment being received by the user interface and before the second rule segment is received by the user interface; and displaying a second simulation result in response to the second rule segment being received by the user interface. The simulation result may be displayed without a user actively prompting processing of the user input. Displaying the simulation result on the user interface may include: asynchronously communicating, with at least one processor, a call to cause an updated simulation result to be received in near real-time relative to receiving the user input; and displaying, with at least one processor, the updated simulation result in near real-time relative to receiving the user input. The at least one proposed fraud detection rule may be associated with at least one parameter, where the historical transaction data is stored in a column-oriented database including a plurality of columns, where a column of the plurality of columns is associated with the at least one parameter, where querying the historical transaction data includes performing a targeted search on the column of the plurality of columns associated with the at least one parameter. The method may include communicating, with at least one processor, a rule implementation message to cause the at least one proposed fraud detection rule to be implemented for electronic payment transactions.

According to non-limiting embodiments or aspects, provided is a system for simulating fraud detection rules including a historical transaction data database configured to store historical transaction data; and at least one processor programmed or configured to: receive user input including at least one proposed fraud detection rule in at least one input field of a user interface; simulate the at least one proposed fraud detection rule by: querying the historical transaction data based on the at least one proposed fraud detection rule; and generating a simulation result for the at least one proposed fraud detection rule based on the queried historical transaction data; and display the simulation result on the user interface, where the simulation result is displayed on the user interface asynchronously and in near real-time relative to receiving the user input.

In non-limiting embodiments or aspects, the simulation result may include effectiveness data associated with the at least one proposed fraud detection rule. The effectiveness data may include at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof. The at least one proposed fraud detection rule may be associated with a data element from ISO 8583. The at least one proposed fraud detection rule may include a plurality of rule segments including a first rule segment and a second rule segment. Displaying the simulation result on the user interface may include the at least one processor being programmed or configured to: display a first simulation result in response to the first rule segment being received by the user interface and before the second rule segment is received by the user interface; and display a second simulation result in response to the second rule segment being received by the user interface. The simulation result may be displayed without a user actively prompting processing of the user input. Displaying the simulation result on the user interface may include the at least one processor being programmed or configured to: asynchronously communicate a call to cause an updated simulation result to be received in near real-time relative to receiving the user input; and display the updated simulation result in near real-time relative to receiving the user input. The at least one proposed fraud detection rule may be associated with at least one parameter, where the historical transaction data is stored in a column-oriented database including a plurality of columns, where a column of the plurality of columns is associated with the at least one parameter, where querying the historical transaction data includes the at least one processor being programmed or configured to perform a targeted search on the column of the plurality of columns associated with the at least one parameter. The at least one processor may be programmed or configured to: communicate a rule implementation message to cause the at least one proposed fraud detection rule to be implemented for electronic payment transactions.

According to non-limiting embodiments or aspects, provided is a computer program product for simulating fraud detection rules including at least one non-transitory computer-readable medium including one or more instructions that, when executed by at least one processor, cause the at least one processor to: receive user input including at least one proposed fraud detection rule in at least one input field of a user interface; simulate the at least one proposed fraud detection rule by: querying historical transaction data based on the at least one proposed fraud detection rule; and generating a simulation result for the at least one proposed fraud detection rule based on the queried historical transaction data; and display the simulation result on the user interface, where the simulation result is displayed on the user interface asynchronously and in near real-time relative to receiving the user input.

In non-limiting embodiments or aspects, the simulation result may include effectiveness data associated with the at least one proposed fraud detection rule. The effectiveness data may include at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof. The at least one proposed fraud detection rule may be associated with a data element from ISO 8583. The at least one proposed fraud detection rule may include a plurality of rule segments including a first rule segment and a second rule segment. Displaying the simulation result on the user interface may include the one or more instructions causing the at least one processor to: display a first simulation result in response to the first rule segment being received by the user interface and before the second rule segment is received by the user interface; and display a second simulation result in response to the second rule segment being received by the user interface. The simulation result may be displayed without a user actively prompting processing of the user input. Displaying the simulation result on the user interface may include the one or more instructions causing the at least one processor to: asynchronously communicate a call to cause an updated simulation result to be received in near real-time relative to receiving the user input; and display the updated simulation result in near real-time relative to receiving the user input. The at least one proposed fraud detection rule may be associated with at least one parameter, where the historical transaction data is stored in a column-oriented database including a plurality of columns, where a column of the plurality of columns is associated with the at least one parameter, where querying the historical transaction data includes the one or more instructions causing the at least one processor to perform a targeted search on the column of the plurality of columns associated with the at least one parameter. The one or more instructions may cause the at least one processor to: communicate a rule implementation message to cause the at least one proposed fraud detection rule to be implemented for electronic payment transactions.

Further non-limiting embodiments or aspects are set forth in the following numbered clauses:

Clause 1: A method for simulating fraud detection rules, comprising: receiving, with at least one processor, user input comprising at least one proposed fraud detection rule in at least one input field of a user interface; simulating, with at least one processor, the at least one proposed fraud detection rule by: querying, with at least one processor, historical transaction data based on the at least one proposed fraud detection rule; and generating, with at least one processor, a simulation result for the at least one proposed fraud detection rule based on the queried historical transaction data; and displaying, with at least one processor, the simulation result on the user interface, wherein the simulation result is displayed on the user interface asynchronously and in near real-time relative to receiving the user input.

Clause 2: The method of clause 1, wherein the simulation result comprises effectiveness data associated with the at least one proposed fraud detection rule.

Clause 3: The method of clause 1 or 2, wherein the effectiveness data comprises at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof.

Clause 4: The method of any of clauses 1-3, wherein the at least one proposed fraud detection rule is associated with a data element from ISO 8583.

Clause 5: The method of any of clauses 1-4, wherein the at least one proposed fraud detection rule comprises a plurality of rule segments comprising a first rule segment and a second rule segment.

Clause 6: The method of any of clauses 1-5, wherein displaying the simulation result on the user interface comprises: displaying a first simulation result in response to the first rule segment being received by the user interface and before the second rule segment is received by the user interface; and displaying a second simulation result in response to the second rule segment being received by the user interface.

Clause 7: The method of any of clauses 1-6, wherein the simulation result is displayed without a user actively prompting processing of the user input.

Clause 8: The method of any of clauses 1-7, wherein displaying the simulation result on the user interface comprises: asynchronously communicating, with at least one processor, a call to cause an updated simulation result to be received in near real-time relative receiving to the user input; and displaying, with at least one processor, the updated simulation result in near real-time relative to receiving the user input.

Clause 9: The method of any of clauses 1-8, wherein the at least one proposed fraud detection rule is associated with at least one parameter, wherein the historical transaction data is stored in a column-oriented database comprising a plurality of columns, wherein a column of the plurality of columns is associated with the at least one parameter, wherein querying the historical transaction data comprises performing a targeted search on the column of the plurality of columns associated with the at least one parameter.

Clause 10: The method of any of clauses 1-9, further comprising: communicating, with at least one processor, a rule implementation message to cause the at least one proposed fraud detection rule to be implemented for electronic payment transactions.

Clause 11: A system for simulating fraud detection rules, comprising: a historical transaction data database configured to store historical transaction data; and at least one processor programmed or configured to: receive user input comprising at least one proposed fraud detection rule in at least one input field of a user interface; simulate the at least one proposed fraud detection rule by: querying the historical transaction data based on the at least one proposed fraud detection rule; and generating a simulation result for the at least one proposed fraud detection rule based on the queried historical transaction data; and display the simulation result on the user interface, wherein the simulation result is displayed on the user interface asynchronously and in near real-time relative to receiving the user input.

Clause 12: The system of clause 11, wherein the simulation result comprises effectiveness data associated with the at least one proposed fraud detection rule.

Clause 13: The system of clause 11 or 12, wherein the effectiveness data comprises at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof.

Clause 14: The system of any of clauses 11-13, wherein the at least one proposed fraud detection rule is associated with a data element from ISO 8583.

Clause 15: The system of any of clauses 11-14, wherein the at least one proposed fraud detection rule comprises a plurality of rule segments comprising a first rule segment and a second rule segment.

Clause 16: The system of any of clauses 11-15, wherein displaying the simulation result on the user interface comprises the at least one processor being programmed or configured to: display a first simulation result in response to the first rule segment being received by the user interface and before the second rule segment is received by the user interface; and display a second simulation result in response to the second rule segment being received by the user interface.

Clause 17: The system of any of clauses 11-16, wherein the simulation result is displayed without a user actively prompting processing of the user input.

Clause 18: The system of any of clauses 11-17, wherein displaying the simulation result on the user interface comprises the at least one processor being programmed or configured to: asynchronously communicate a call to cause an updated simulation result to be received in near real-time relative to receiving the user input; and display the updated simulation result in near real-time relative to receiving the user input.

Clause 19: The system of any of clauses 11-18, wherein the at least one proposed fraud detection rule is associated with at least one parameter, wherein the historical transaction data is stored in a column-oriented database comprising a plurality of columns, wherein a column of the plurality of columns is associated with the at least one parameter, wherein querying the historical transaction data comprises the at least one processor being programmed or configured to perform a targeted search on the column of the plurality of columns associated with the at least one parameter.

Clause 20: The system of any of clauses 11-19, wherein the at least one processor is programmed or configured to: communicate a rule implementation message to cause the at least one proposed fraud detection rule to be implemented for electronic payment transactions.

Clause 21: A computer program product for simulating fraud detection rules, the computer program product comprising at least one non-transitory computer-readable medium including one or more instructions that, when executed by at least one processor, cause the at least one processor to: receive user input comprising at least one proposed fraud detection rule in at least one input field of a user interface; simulate the at least one proposed fraud detection rule by: querying historical transaction data based on the at least one proposed fraud detection rule; and generating a simulation result for the at least one proposed fraud detection rule based on the queried historical transaction data; and display the simulation result on the user interface, wherein the simulation result is displayed on the user interface asynchronously and in near real-time relative to receiving the user input.

Clause 22: The computer program product of clause 21, wherein the simulation result comprises effectiveness data associated with the at least one proposed fraud detection rule.

Clause 23: The computer program product of clause 21 or 22, wherein the effectiveness data comprises at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof.

Clause 24: The computer program product of any of clauses 21-23, wherein the at least one proposed fraud detection rule is associated with a data element from ISO 8583.

Clause 25: The computer program product of any of clauses 21-24, wherein the at least one proposed fraud detection rule comprises a plurality of rule segments comprising a first rule segment and a second rule segment.

Clause 26: The computer program product of any of clauses 21-25, wherein displaying the simulation result on the user interface comprises the one or more instructions causing the at least one processor to: display a first simulation result in response to the first rule segment being received by the user interface and before the second rule segment is received by the user interface; and display a second simulation result in response to the second rule segment being received by the user interface.

Clause 27: The computer program product of any of clauses 21-26, wherein the simulation result is displayed without a user actively prompting processing of the user input.

Clause 28: The computer program product of any of clauses 21-27, wherein displaying the simulation result on the user interface comprises the one or more instructions causing the at least one processor to: asynchronously communicate a call to cause an updated simulation result to be received in near real-time relative to receiving the user input; and display the updated simulation result in near real-time relative to receiving the user input.

Clause 29: The computer program product of any of clauses 21-28, wherein the at least one proposed fraud detection rule is associated with at least one parameter, wherein the historical transaction data is stored in a column-oriented database comprising a plurality of columns, wherein a column of the plurality of columns is associated with the at least one parameter, wherein querying the historical transaction data comprises the one or more instructions causing the at least one processor to perform a targeted search on the column of the plurality of columns associated with the at least one parameter.

Clause 30: The computer program product of any of clauses 21-29, wherein the one or more instructions cause the at least one processor to: communicate a rule implementation message to cause the at least one proposed fraud detection rule to be implemented for electronic payment transactions.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for simulating fraud detection rules according to some non-limiting embodiments or aspects;

FIG. 2 is a user interface in an existing system for simulating fraud detection rules;

FIG. 3A is a user interface in response to receiving a first rule segment in a system for simulating fraud detection rules according to some non-limiting embodiments or aspects;

FIG. 3B is a user interface in response to receiving a second rule segment in a system for simulating fraud detection rules according to some non-limiting embodiments or aspects;

FIG. 3C is a user interface in response to receiving a third rule segment in a system for simulating fraud detection rules according to some non-limiting embodiments or aspects;

FIG. 4A is an existing row-oriented database for storing historical transaction data; and

FIG. 4B a column-oriented database for storing historical transaction data according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may include one or more types of identifiers associated with a user account (e.g., a PAN, a primary account number, a card number, a payment card number, a token, and/or the like). In some non-limiting embodiments or aspects, an issuer institution may provide an account identifier (e.g., a PAN, a token, and/or the like) to a user that uniquely identifies one or more accounts associated with that user. The account identifier may be embodied on a payment device (e.g., a portable payment instrument, a payment card, a credit card, a debit card, and/or the like) and/or may be electronic information communicated to the user that the user may use for electronic payments. In some non-limiting embodiments or aspects, the account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments or aspects, an account identifier may be directly or indirectly associated with an issuer institution such that an account identifier may be a token that maps to a PAN or another type of identifier. Account identifiers may be alphanumeric, any combination of characters and/or symbols, and/or the like. An issuer institution may be associated with a bank identification number (BIN) that uniquely identifies the issuer institution.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the terms “communication” and “communicate” may refer to the reception, receipt, transmission, transfer, provision, and/or the like, of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a payment device, such as a physical financial instrument, e.g., a payment card, and/or may be electronic and used for electronic payments. The term “issuer system” refers to one or more computing devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to users (e.g., users) based on a transaction (e.g., a payment transaction). The term “merchant system” may refer to one or more computer systems, computing devices, and/or software applications operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “payment device” may refer to a portable financial device, an electronic payment device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like operated by or on behalf of a payment gateway.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” As used herein, the term “server” or “processor” may refer to one or more devices that provide a functionality to one or more devices (e.g., one or more client devices) via a network (e.g., a public network, a private network, the Internet, and/or the like). For example, a server may include one or more computing devices. As used herein, the term “system” may refer to one or more devices, such as one or more processors, servers, client devices, computing devices that include software applications, and/or the like. In some non-limiting embodiments or aspects, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

Non-limiting embodiments or aspects of the present disclosure are directed to a method, system, and computer program product for simulating fraud detection rules. Non-limiting embodiments or aspects enable display of simulated results associated with proposed fraud rules to be displayed on the user interface asynchronously and in near real-time relative to receiving the user input (e.g., proposed fraud rule) from the user (e.g., rule author). The simulation results may be based on historical transaction data. First simulation results may be displayed in response to a first rule segment being received and before a second rule segment is received, and second simulation results may be displayed (as updated simulation results) in response to receiving the second rule segment. The simulation results may be displayed without the user actively prompting processing of the proposed fraud rules. Non-limiting embodiments or aspects enable asynchronous calls to the historical transaction data database, such that the updated simulation result may be generated and displayed in near real-time relative to the user input. In this way, the user may constantly be updated with the simulation results at the same time the fraud rules is being authored and/or refined. The historical transaction data in the historical transaction database may be stored in a column-oriented data structure which enables the updated simulation data to be generated faster than was previously available in existing systems. Non-limiting embodiments or aspects enable a user to more efficiently test proposed fraud rules and view the simulated results faster, such that the user may more efficiently determine which fraud rules should be implemented during transaction processing. Overall, the system for processing transactions may utilize the newly developed rules sooner, allowing fraudulent transactions initiated over the electronic payment processing network to be identified sooner.

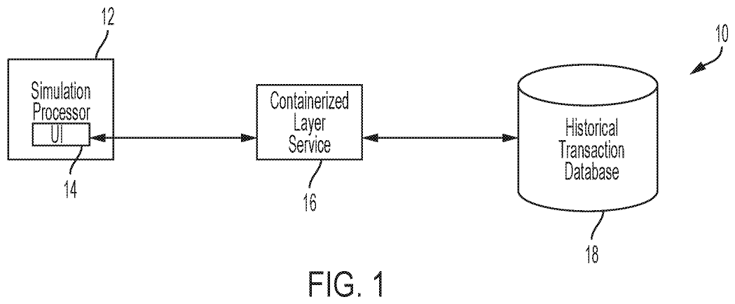

Referring to FIG. 1, a system 10 for simulating fraud detection rules is shown according to some non-limiting embodiments or aspects. The system may include a simulation processor 12 of a computing device on which a simulation user interface (UI) 14 is displayed. The simulation UI 14 may be configured to receive user input from a user. The simulation UI 14 may receive proposed fraud detection rules as user input, such that the proposed fraud detection rules can be simulated to test their effectiveness. The simulation UI 14 may include at least one input field for receiving the user input (e.g., the proposed fraud detection rules). The input field may be a freeform field, dropdown menu, radio button, or any other suitable type of input field known to those skilled in the art.

The proposed fraud detection rule may be entered into the input field by an issuer (e.g., an issuer system), such as an issuer of payment devices. The proposed fraud detection rule may include at least one parameter which may be analyzed during processing of an electronic payment transaction over an electronic payment processing network as a potential indicator of a fraudulent payment transaction. The electronic payment processing network may include a network of systems communicating to process (e.g., authorize, clear, settle) an electronic payment processing network and may include at least one of the following systems: a merchant system, an acquirer system, a payment gateway system, a transaction processing system, and an issuer system. The proposed fraud detection rule may include a plurality of parameters or rules associated with the same parameter, such that the proposed fraud detection rule includes a plurality of rule segments, each rule segment associated with at least one of the plurality of parameters.

The parameter of the proposed fraud detection rule may include any parameter suitable for potentially detecting a fraudulent payment transaction. The parameter may be associated with a data element from ISO 8583 (see Table 1 below) or any other data parameter used and/or generated by the electronic payment processing network to process electronic payment transactions.

TABLE 1

| Data Field | Usage |
|---|---|
| 1 | Bit map |
| 2 | Primary account number (PAN) |
| 3 | Processing code |
| 4 | Amount, transaction |
| 5 | Amount, settlement |
| 6 | Amount, cardholder billing |
| 7 | Transmission date & time |
| 8 | Amount, cardholder billing fee |
| 9 | Conversion rate, settlement |
| 10 | Conversion rate, cardholder billing |
| 11 | System trace audit number (STAN) |
| 12 | Time, local transaction (hhmmss) |
| 13 | Date, local transaction (MMDD) |
| 14 | Date, expiration |
| 15 | Date, settlement |
| 16 | Date, conversion |
| 17 | Date, capture |
| 18 | Merchant type |
| 19 | Acquiring institution country code |
| 20 | PAN extended, country code |
| 21 | Forwarding institution. country code |
| 22 | Point of service entry mode |
| 23 | Application PAN sequence number |
| 24 | Function code (ISO 8583:1993)/Network |
| | International identifier (NII) |
| 25 | Point of service condition code |
| 26 | Point of service capture code |
| 27 | Authorizing identification response length |
| 28 | Amount, transaction fee |
| 29 | Amount, settlement fee |
| 30 | Amount, transaction processing fee |
| 31 | Amount, settlement processing fee |
| 32 | Acquiring institution identification code |
| 33 | Forwarding institution identification code |
| 34 | Primary account number, extended |
| 35 | Track 2 data |
| 36 | Track 3 data |
| 37 | Retrieval reference number |
| 38 | Authorization identification response |
| 39 | Response code |
| 40 | Service restriction code |
| 41 | Card acceptor terminal identification |
| 42 | Card acceptor identification code |
| 43 | Card acceptor name/location (1-23 address; |
| | 24-36 city; 37-38 state; 39-40 country) |
| 44 | Additional response data |
| 45 | Track 1 data |
| 46 | Additional data - ISO |
| 47 | Additional data - national |
| 48 | Additional data - private |
| 49 | Currency code, transaction |
| 50 | Currency code, settlement |
| 51 | Currency code, cardholder billing |
| 52 | Personal identification number data |
| 53 | Security related control information |
| 54 | Additional amounts |
| 55 | Reserved ISO |
| 56 | Reserved ISO |
| 57-60 | Reserved national |
| 61-63 | Reserved private |
| 64 | Message authentication code (MAC) |
| 65 | Bitmap, extended |
| 66 | Settlement code |
| 67 | Extended payment code |
| 68 | Receiving institution country code |
| 69 | Settlement institution country code |
| 70 | Network management information code |
| 71 | Message number |
| 72 | Message number, last |
| 73 | Date, action (YYMMDD) |
| 74 | Credits, number |
| 75 | Credits, reversal number |
| 76 | Debits, number |
| 77 | Debits, reversal number |
| 78 | Transfer number |
| 79 | Transfer, reversal number |
| 80 | Inquiries number |
| 81 | Authorizations, number |
| 82 | Credits, processing fee amount |
| 83 | Credits, transaction fee amount |
| 84 | Debits, processing fee amount |
| 85 | Debits, transaction fee amount |
| 86 | Credits, amount |
| 87 | Credits, reversal amount |
| 88 | Debits, amount |
| 89 | Debits, reversal amount |
| 90 | Original data elements |
| 91 | File update code |
| 92 | File security code |
| 93 | Response indicator |
| 94 | Service indicator |
| 95 | Replacement amounts |
| 96 | Message security code |
| 97 | Amount, net settlement |
| 98 | Payee |
| 99 | Settlement institution |
| | identification code |
| 100 | Receiving institution |
| | identification code |
| 101 | File name |
| 102 | Account identification 1 |
| 103 | Account identification 2 |
| 104 | Transaction description |
| 105-111 | Reserved for ISO use |
| 112-119 | Reserved for national use |
| 120-127 | Reserved for private use |
| 128 | Message authentication code |

The proposed fraud detection rule may specify certain parameters, values associated with parameters, and/or the like that may indicate that a payment transaction may be a fraudulent payment transaction. For example, the presence or absence of a certain parameter in a payment transaction may be an indicator of potential fraud (per the proposed fraud detection rule). For example, certain values or ranges of values of a parameter may be an indicator of potential fraud (per the proposed fraud detection rule), such as a transaction amount being greater than, less than, and/or equal to a specific value indicating potential fraud. For proposed fraud detection rules including a plurality of rule segments, each of the rule segments of the proposed fraud rule indicating potential fraud may be satisfied to indicate a potentially fraudulent transaction. In this way, the proposed fraud detection rules may be used to identify potentially fraudulent payment transactions.

The issuer (or other user) may simulate proposed fraud detection rules to determine how effective a proposed fraud detection rule may be for detecting potentially fraudulent transactions.

The simulation processor 12 may communicate the proposed fraud detection rule optionally to a containerized layer service 16. The simulation processor 12 may communicate the proposed fraud detection rule to a historical transaction database 18 to query the historical transaction data contained therein.

The containerized layer service 16 may enable horizontal scaling of proposed fraud detection rule simulation, such that multiple issuers may query the historical transaction database 18 to simultaneously execute proposed fraud detection rule simulations. In response to receiving a proposed fraud detection rule, the containerized layer service 16 may generate a container containing at least a portion of the historical transaction data contained in the historical transaction database 18, such that the proposed fraud detection rule may be simulated by the issuer.

The historical transaction data base 18 may include historical transaction data from previously processed (completely and/or incompletely) electronic payment transactions. The historical transaction data may include data associated with payment transactions initiated by a payment device issued by the issuer to a user and/or may include data associated with payment transactions initiated by a payment device issued by other issuers to users. The historical transaction data may include the data associated with the ISO 8583 and/or other data parameters generated by and/or used in processing the previously processed electronic payment transactions. The simulation processor 12 may query the historical transaction database 18 and generate a simulation result for the proposed fraud detection rule based on the query.

The proposed fraud detection rule may specify a date over which the historical transaction data is to be queried. For example, the proposed fraud detection rule may specify that the historical transaction data to be queried be historical transaction data from the most recent day, week, month, quarter, year, or the like. This may enable simulation of the proposed fraud detection rule relative to the most recent and/or relevant historical transaction data, so as to evaluate recent trends in payment transaction fraud.

With continued reference to FIG. 1, the proposed fraud detection rule may be simulated by querying the historical transaction data based on the parameter(s) of the proposed fraud detection rule. Based on the query, the simulation processor 12 may generate the simulation result for the proposed fraud detection rule, and the simulation result may be displayed on the simulation UI 14.

The simulation result may be displayed on the simulation UI 14 asynchronously and in near real-time relative to receiving the user input (the proposed fraud detection rule). As used herein, the term “asynchronously” displayed (relative to the user) means that the simulation result is displayed on the simulation UI 14 without the user actively prompting processing of the user input to simulate and display the simulation result. Actively prompting includes the user selecting a selectable option to cause the simulation processor 12 to simulate and display the proposed fraud detection rule. In this way, updated simulation results may be displayed before a user actively prompts display thereof.

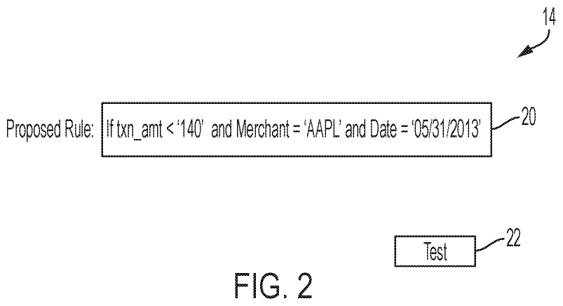

Referring to FIG. 2, in an existing UI 14 for simulating proposed fraud detection rules, the proposed fraud detection rule may be inputted to an input field 20 on the UI 14. However, the simulation result may not be displayed in direct response to the proposed fraud detection rule being inputted into the input field 20. Instead, for these existing systems, the user must actively select a selectable option 22 (e.g., the ‘Test’ button) to cause the simulation to be run and the result eventually displayed, so as to operate synchronously relative to the user.

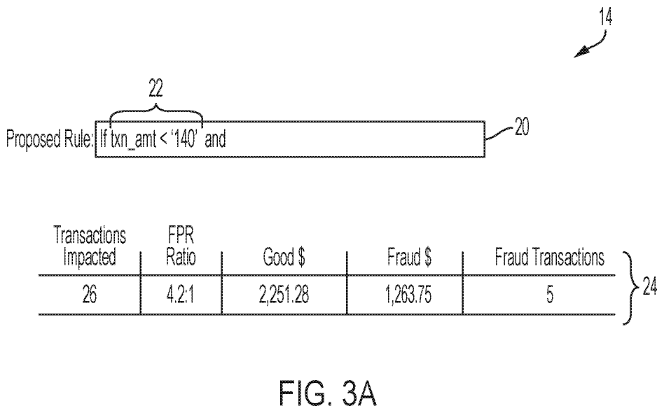

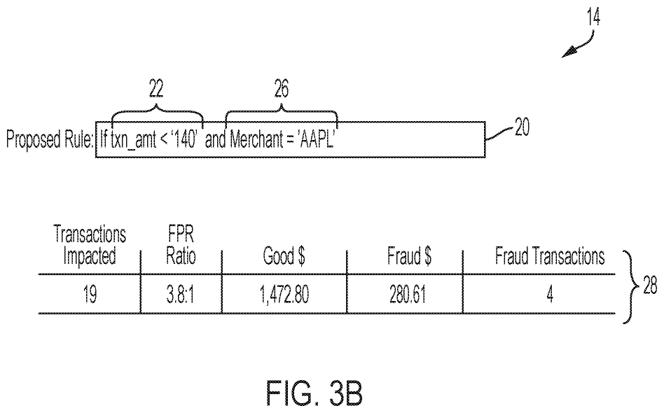

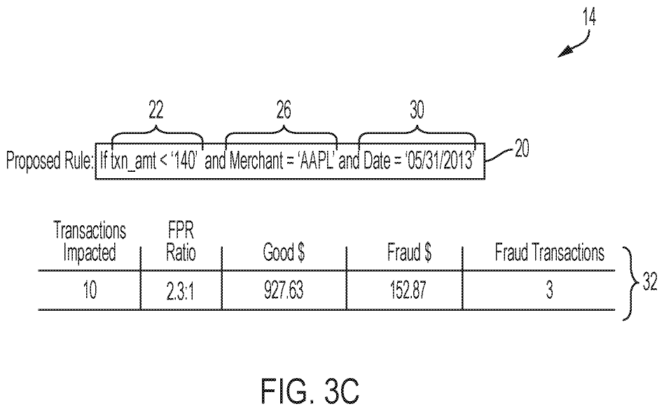

In contrast, referring to FIGS. 3A-3C, the simulation result 24, 28, 32 may be asynchronously displayed without the user actively prompting processing of the user input. Instead, the simulation result 24, 28, 32 may be displayed in direct response to the user entering the proposed fraud detection rule into the input field 20 and without the user selecting a selectable option to cause simulation of the proposed fraud detection rule.

With continued reference to FIGS. 3A-3C, the simulation result 24, 28, 32 may be displayed on the simulation UI 14 in near real-time relative to receiving the user input. As used herein, the term “near real-time” means that the data is displayed nearly instantaneously, such as during or immediately after the proposed fraud detection rule is inputted into the input field 20. The simulation result may be displayed less than 1 minute, such as less than 30 seconds, less than 20 seconds, less than 15 seconds, less than 10 seconds, less than 5 seconds, less than 2 seconds, less than 1 second, less than 0.5 seconds after entry of the proposed fraud detection rule into the input field 20.

In some non-limiting embodiments or aspects, the proposed fraud detection rule may include a plurality of rule segments, and the simulation result may be displayed on the simulation UI 14 after a first rule segment 22 is inputted into the input field and before a second rule segment 26 is inputted into the input field 20. This feature is shown in FIGS. 3A-3C and described in more detail below.

Referring to FIG. 3A, a first rule segment 22 (transaction amount less than $140) may be inputted into the input field 20 of the simulation UI 14. Asynchronously and in near real-time, a first simulation result 24 may be displayed on the simulation UI 14 before any subsequent rule segments are inputted. The first simulation result 24 may include simulation results based only on the first rule segment 22.

Referring to FIG. 3B, a second rule segment 26 may be added to the proposed fraud detection rule (in addition to the first rule segment 22) by inputting the second rule segment 26 into the input field 20. Asynchronously and in near real-time, a second simulation result 28 may replace the first simulation result 24, and the second simulation result 28 may be displayed on the simulation UI 14 before any subsequent rule segments are inputted. The second simulation result 28 may include simulation results based only on the first and second rule segments 22, 26.

Referring to FIG. 3C, a third rule segment 30 may be added to the proposed fraud detection rule (in addition to the first rule segment 22 and second rule segment 26) by inputting the third rule segment 30 into the input field 20. Asynchronously and in near real-time, a third simulation result 32 may replace the second simulation result 28, and the third simulation result 32 may be displayed on the simulation UI 14 before any subsequent rule segments are inputted. The third simulation result 32 may include simulation results based only on the first, second, and third rule segments 22, 26, 30.

Referring to FIGS. 3A-3C, the proposed fraud detection rule example includes the first, second, and third rule segments 22, 26, 30. It will be appreciated that more or fewer than three rule segments may be included in a proposed fraud detection rule, and the proposed fraud detection rule shown in FIGS. 3A-3C is non-limiting and for example purposes only.

With continued reference to FIGS. 3A-3C, as previously described, the simulation result(s) may be displayed asynchronously and in near real-time relative to receiving at least a portion of the user input. The simulation result may be displayed in this manner by the simulation processor 12 asynchronously communicating with the historical transaction database 18. The simulation processor 12 may asynchronously communicate with the historical transaction database 18 via at least one call containing the proposed fraud detection rule to obtain the most up-to-date simulation results (updated simulation result). The updated simulation result may be displayed asynchronously and in near real-time relative to receiving the user input in response to the call.

The simulation results and/or updated simulation results may be displayed asynchronously and in near real-time by enabling the simulation processor 12 to make REST calls to the historical transaction database 18. For example, an Angular component may enable AJAX calls to be made asynchronously to the historical transaction database 18 to receive and display the simulation results or updated simulation results in near real-time. As used herein, the term “asynchronous” calls refers to calls being communicated without the user actively (e.g., selecting a selectable option to directly cause the call to be made) requesting that the call be communicated. These asynchronous calls may include a client side sending and/or retrieving data from a server side without interfering with display and behavior of the current simulation UI 14 and without the user actively requesting the page to be refreshed (e.g., the call is “asynchronous” relative to active user steps). In this way, the simulation UI 14 (and/or certain portions thereof) may be updated without active user prompting and may be updated more frequently than as actively requested by the user. It will be appreciated that any technique for making asynchronous calls to the historical transaction database 18 so as to continuously and in near real-time display the simulation result and/or updated simulation result without interfering with the current display of the simulation UI 14 may be executed, so that the most recent simulation result is displayed on the simulation UI 14.

With continued reference to FIGS. 3A-3C, the simulation result 24, 28, 32 may include effectiveness data, which may be displayed on the simulation UI 14. The effectiveness data may be associated with the proposed fraud detection rule, such that the effectiveness data reflects the proposed fraud detection rule's effectiveness in identifying fraudulent transactions (based on the historical transaction data).

The effectiveness data may include any statistical data which illustrates the proposed fraud detection rule's effectiveness in identifying fraudulent transactions. Non-limiting examples of effectiveness data includes: a total number of transactions affected by the at least one proposed fraud detection rule (e.g., a count of transactions that satisfy the proposed fraud detection rule), an aggregate currency amount affected by the at least one proposed fraud detection rule (e.g., an amount for transactions that satisfy the proposed fraud detection rule), a total number of historical transactions approved or denied by the at least one proposed fraud detection rule, a total amount of fraud loss prevented by the at least one proposed fraud detection rule, a total amount of non-fraudulent currency prevented by the at least one proposed fraud detection rule, a false positive transaction ratio (FPR) from the at least one proposed fraud detection rule (non-fraudulent transaction count/fraudulent transaction count), a true positive ratio from the at least one proposed fraud detection rule (fraudulent transaction count/non-fraudulent transaction count), a false positive percentage from the at least one proposed fraud detection rule (non-fraudulent transaction count/total affected transaction count), a true positive percentage from the at least one proposed fraud detection rule (fraudulent transaction count/total affected transaction count), and the like.

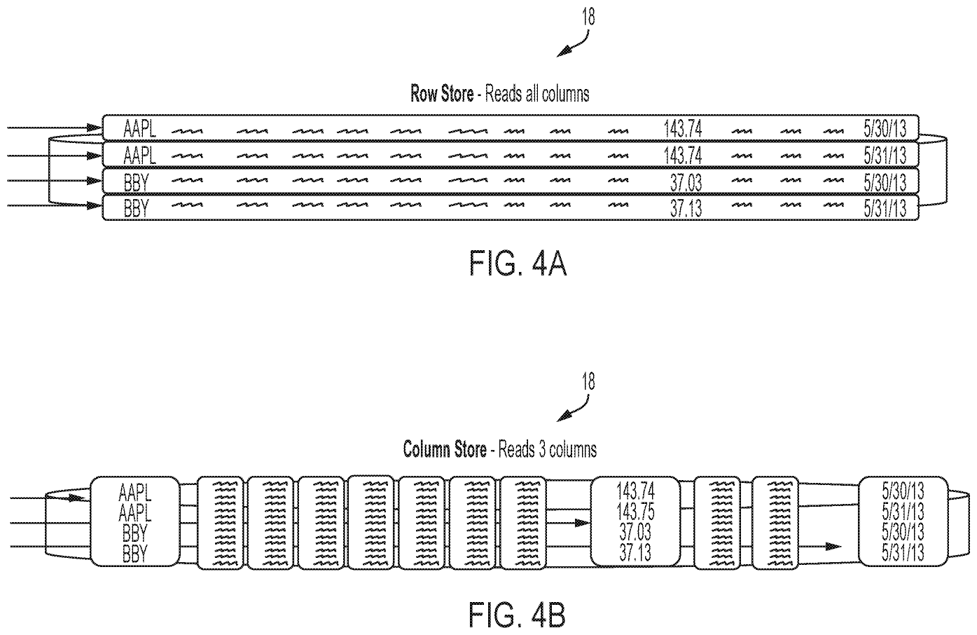

Referring to FIGS. 4A-4B, as previously discussed the simulation result may be displayed on the simulation UI 14 asynchronously and in near real-time. However, the historical transaction database 18 may contain a large volume of historical transaction data (e.g., billions of electronic payment transactions may be initiated each year). The system 10 may utilize a querying technique that enables the simulation results to be generated and displayed in near real-time. Any suitable querying technique may be used. In one non-limiting example, Druid storage technology may be utilized.

The historical transaction database 18 may include a data structure that enables the simulation results to be generated and displayed in near real-time through querying the historical transaction database 18. Existing databases queried for generating simulation results for proposed fraud detection rules utilize the data structure shown in FIG. 4A, which has a row-oriented database. Such a data structure causes the query to read all columns of the data, and not just relevant columns as defined by the proposed fraud detection rule.

Referring to FIG. 4B, a data structure is shown which enables the simulation results to be generated and displayed near real-time through querying the historical transaction database 18. This data structure includes a column-oriented database containing a plurality of columns. The columns may corresponds to each of the parameters which may be included in a proposed fraud detection rule. The query according to this data structure may read only those columns defined as relevant by the proposed fraud detection rules (a targeted search) and may forgo reading columns not relevant to the proposed fraud detection rule. Therefore, the column-oriented database may enable faster querying of the historical transaction database 18, which may include a voluminous amount of historical transaction data in some non-limiting embodiments or aspects, such that the simulation results may be generated and displayed in near real-time.

Referring back to FIG. 1, in response to simulation results associated with a proposed fraud detection rule being displayed on the simulation UI 14, the user (e.g., the issuer system) may accept or reject the proposed fraud detection rule. The proposed fraud detection rule may be accepted or rejected based on the effectiveness data, such that only proposed fraud detection rules that effectively identify fraudulent transactions are accepted and implemented. The proposed fraud detection rule may be accepted or rejected in response to effectiveness data satisfying and/or not satisfying certain implementation criteria.

In response to the user rejecting a proposed fraud detection rule, the proposed fraud detection rule may not be implemented by the electronic payment processing network. The issuer may continue simulating proposed fraud detection rules for more effective proposed fraud detection rules.

In response to the user accepting a proposed fraud detection rule, the proposed fraud detection rule may be implemented by the electronic payment processing network. The simulation processor 12 may communicate the proposed fraud detection rule to the electronic payment processing network to cause the proposed fraud detection rule to be implemented for payment transactions. The simulation processor 12 may communicate the proposed fraud detection rule for implementation to at least one of the following systems operating in the electronic payment processing network: an issuer system operated by or on behalf of an issuer, a transaction processing system operated by or on behalf of a transaction service provider, a payment gateway system operated by or on behalf of a payment gateway, an acquirer system operated by or on behalf of an acquirer, a merchant system operated by or on behalf of a merchant, and the like.

The simulation processor 12 may cause the proposed fraud detection rule to be implemented as a real-time rule or a case creation rule. The term “real-time rule” refers to a fraud detection rule which is applied during processing of a payment transaction, such that the transaction is authorized or denied at least in part on application of the rule. The payment transaction satisfying the real-time rule may cause the electronic payment processing network to terminate processing of the payment transaction, while the payment transaction not satisfying the real-time rule may cause the electronic payment processing network to continue processing of the payment transaction. The term “case creation rule” refers to a fraud detection rule which marks a transaction as potentially fraudulent during processing of the payment transaction if the rule is satisfied, and which causes the issuer system to initiate a follow-up action related to the payment transaction to determine whether the payment transaction is actually fraudulent. The follow-up action may occur after authorization of the payment transaction.

A payment transaction satisfying an implemented fraud detection rule may cause the electronic payment processing network to initiate a fraud prevention protocol. The fraud prevention protocol may include communicating with at least one of a computing device of a user (or directly with the user), the issuer system, the transaction processing system, and the like to notify the user and/or system(s) of a potential fraudulent transaction, such that the appropriate fraud prevention action can be taken.

A method for simulating fraud detection rules may include the simulation processor receiving user input including at least one proposed fraud detection rule in at least one input field of the simulation UI. The simulation processor may simulate the at least one proposed fraud detection rule. Simulating the at least one proposed fraud detection rule may include the simulation processor querying the historical transaction data in the historical transaction database based on the at least one proposed fraud detection rule. Simulating the at least one proposed fraud detection rule may include the simulation processor generating a simulation result for the at least one proposed fraud detection rule based on the queried historical transaction data. The simulation processor may cause the simulation result to be displayed on the simulation UI. The simulation result may be displayed on the user interface asynchronously and in near real-time relative to receiving the user input.

In a further, non-limiting embodiment or aspect, a computer program product for simulating fraud detection rules includes at least one non-transitory computer readable medium including program instructions that, when executed by at least one processor, cause the at least one processor to execute one of the previously-described methods. The at least one processor may include the simulation processor.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method for simulating fraud detection rules, comprising:
receiving, with at least one processor, user input comprising at least one proposed fraud detection rule in at least one input field of a user interface;
simulating, with at least one processor, the at least one proposed fraud detection rule by: querying, with at least one processor, historical transaction data based on the at least one proposed fraud detection rule; and generating, with at least one processor, a simulation result for the at least one proposed fraud detection rule based on the queried historical transaction data; and
displaying, with at least one processor, the simulation result on the user interface, wherein the simulation result is displayed on the user interface asynchronously and in near real-time relative to receiving the user input.

2. The method of claim 1, wherein the simulation result comprises effectiveness data associated with the at least one proposed fraud detection rule.

3. The method of claim 2, wherein the effectiveness data comprises at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof.

4. The method of claim 1, wherein the at least one proposed fraud detection rule is associated with a data element from ISO 8583.

5. The method of claim 1, wherein the at least one proposed fraud detection rule comprises a plurality of rule segments comprising a first rule segment and a second rule segment.

6. The method of claim 5, wherein displaying the simulation result on the user interface comprises:
displaying a first simulation result in response to the first rule segment being received by the user interface and before the second rule segment is received by the user interface; and
displaying a second simulation result in response to the second rule segment being received by the user interface.

7. The method of claim 1, wherein the simulation result is displayed without a user actively prompting processing of the user input.

8. The method of claim 1, wherein displaying the simulation result on the user interface comprises:
asynchronously communicating, with at least one processor, a call to cause an updated simulation result to be received in near real-time relative to receiving the user input; and
displaying, with at least one processor, the updated simulation result in near real-time relative to receiving the user input.

9. The method of claim 1, wherein the at least one proposed fraud detection rule is associated with at least one parameter,
wherein the historical transaction data is stored in a column-oriented database comprising a plurality of columns, wherein a column of the plurality of columns is associated with the at least one parameter,
wherein querying the historical transaction data comprises performing a targeted search on the column of the plurality of columns associated with the at least one parameter.

10. The method of claim 1, further comprising:
communicating, with at least one processor, a rule implementation message to cause the at least one proposed fraud detection rule to be implemented for electronic payment transactions.

11. A system for simulating fraud detection rules, comprising:
a historical transaction data database configured to store historical transaction data; and
at least one processor programmed or configured to:
receive user input comprising at least one proposed fraud detection rule in at least one input field of a user interface;
simulate the at least one proposed fraud detection rule by:
querying the historical transaction data based on the at least one proposed fraud detection rule; and
generating a simulation result for the at least one proposed fraud detection rule based on the queried historical transaction data; and
display the simulation result on the user interface, wherein the simulation result is displayed on the user interface asynchronously and in near real-time relative to receiving the user input.

12. The system of claim 11, wherein the simulation result comprises effectiveness data associated with the at least one proposed fraud detection rule.

13. The system of claim 12, wherein the effectiveness data comprises at least one of: a total number of transactions affected by the at least one proposed fraud detection rule, an aggregate currency amount affected by the at least one proposed fraud detection rule, a total number of historical transactions approved or denied by the at least one proposed fraud detection rule, a total amount of fraud loss prevented by the at least one proposed fraud detection rule, a false positive transaction ratio from the at least one proposed fraud detection rule, a true positive ratio from the at least one proposed fraud detection rule, or any combination thereof.

14. The system of claim 11, wherein the at least one proposed fraud detection rule is associated with a data element from ISO 8583.

15. The system of claim 11, wherein the at least one proposed fraud detection rule comprises a plurality of rule segments comprising a first rule segment and a second rule segment.

16. The system of claim 15, wherein displaying the simulation result on the user interface comprises the at least one processor being programmed or configured to:
display a first simulation result in response to the first rule segment being received by the user interface and before the second rule segment is received by the user interface; and
display a second simulation result in response to the second rule segment being received by the user interface.

17. The system of claim 11, wherein the simulation result is displayed without a user actively prompting processing of the user input.

18. The system of claim 11, wherein displaying the simulation result on the user interface comprises the at least one processor being programmed or configured to:
asynchronously communicate a call to cause an updated simulation result to be received in near real-time relative to receiving the user input; and
display the updated simulation result in near real-time relative to receiving the user input.

19. The system of claim 11, wherein the at least one proposed fraud detection rule is associated with at least one parameter, wherein the historical transaction data is stored in a column-oriented database comprising a plurality of columns, wherein a column of the plurality of columns is associated with the at least one parameter, and wherein querying the historical transaction data comprises the at least one processor being programmed or configured to perform a targeted search on the column of the plurality of columns associated with the at least one parameter.

20. A computer program product for simulating fraud detection rules, the computer program product comprising at least one non-transitory computer-readable medium including one or more instructions that, when executed by at least one processor, cause the at least one processor to:
receive user input comprising at least one proposed fraud detection rule in at least one input field of a user interface;
simulate the at least one proposed fraud detection rule by:
querying historical transaction data based on the at least one proposed fraud detection rule; and
generating a simulation result for the at least one proposed fraud detection rule based on the queried historical transaction data; and
display the simulation result on the user interface, wherein the simulation result is displayed on the user interface asynchronously and in near real-time relative to receiving the user input.
